(19) United States
(12) Patent Application Publication
(10) Pub. No.: US 2011/0149158 A1
(43) Pub. Date: Jun. 23, 2011

(54) APPARATUS AND METHOD FOR ACCESSING A PORTABLE MEDIA PLAYER

(75) Inventors: Steven L. Cooper, Whitestown, IN (US); Khelan M. Modi, Fishers, IN (US)

(73) Assignee: SHENZHEN TCL NEW TECHNOLOGY LTD., Shekou, Shenzhen, Guangdong (CN)

(21) Appl. No.: 13/060,350

(22) PCT Filed: Nov. 21, 2008
(86) PCT No.: PCT/US08/84341

§ 371 Date: Feb. 23, 2011

(30) Foreign Application Priority Data
Sep. 5, 2008 (CN) 200810212127.4

(51) Int. Cl. H04N 7/00; H04N 5/445

(52) U.S. Cl. 348/552; 348/E07.091; 348/E05.099

(57) ABSTRACT

An electronic device includes a first input for receiving a portable media player and is configured to receive data from the portable media player while the first input is selected. The device also includes an input device configured to send a control signal that cyclically selects each of a plurality of inputs. A method of using the device to access the portable media player may include receiving a control signal that designates a first input and selecting the first input from a plurality of inputs in response to the control signal.

### FIELD OF THE INVENTION

The present invention relates generally to electronic devices, such as televisions. More specifically, the present invention relates to electronic devices that support control of a portable media player.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Electronic devices, such as televisions, are often coupled to portable media players and used to play media files, such as audio files, video files, and digital picture files, stored on the portable media players. For example, a portable media player may be connected to an electronic device using a connection, such as a serial cable that serves as one of various inputs to the electronic device. The connection may allow audio and video signals to be communicated between the portable media player and the electronic device when the portable media player is selected as a media source. In conventional applications, a user may select the portable media player as a media source for the electronic device (e.g., a television) by navigating through a series of menus or by actuating a designated button on a remote control. The navigation steps required to access the portable media player may be time consuming and/or difficult for a user to remember or apply, and the inclusion of a designated button may increase costs and/or decrease manufacturing flexibility.

### BRIEF DESCRIPTION OF THE DRAWINGS

In the drawings:

FIG. 1 is a block diagram of an electronic device in accordance with present embodiments;

FIG. 2 is a front elevational view of an electronic device connected to a portable media player in accordance with present embodiments;

FIG. 3 is a top elevational view of an input device in accordance with present embodiments; and

FIG. 4 is a process flow diagram of a method for operating an electronic device in accordance with present embodiments.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed to an electronic device that includes one or more dedicated inputs for a portable media player. Such a dedicated input may be selected as the media source by a user through input switching without accessing a special navigation menu or actuating a dedicated button on a remote control. In the illustrated embodiment, the dedicated input may be selected by repeatedly pressing an input button on a remote control. Each press of the input button may switch the device to an available input in a cyclical manner. For example, the input button may be configured to cycle the device between an S-Video input, the dedicated input for the portable media player, and a cable input. A user may press the input button until the desired input is selected. Separate buttons and/or menu configurations are not required to access the portable media player.

When the portable media player input is selected, the device may be configured to control the portable media player. According to certain embodiments, the device may enter a context sensitive mode that facilitates control of the portable media player through the electronic device. For example, a guide button on the remote control may be configured to serve dual purposes. When the cable input is selected as the media source, actuation of the guide button may cause a programming guide to be displayed on the electronic device. When the portable media player input is selected as the media source, actuation of the same guide button may cause a guide or content list for the portable media player to be displayed on the electronic device. The context sensitive mode allows existing electronic device controls to be used to control the portable media player.

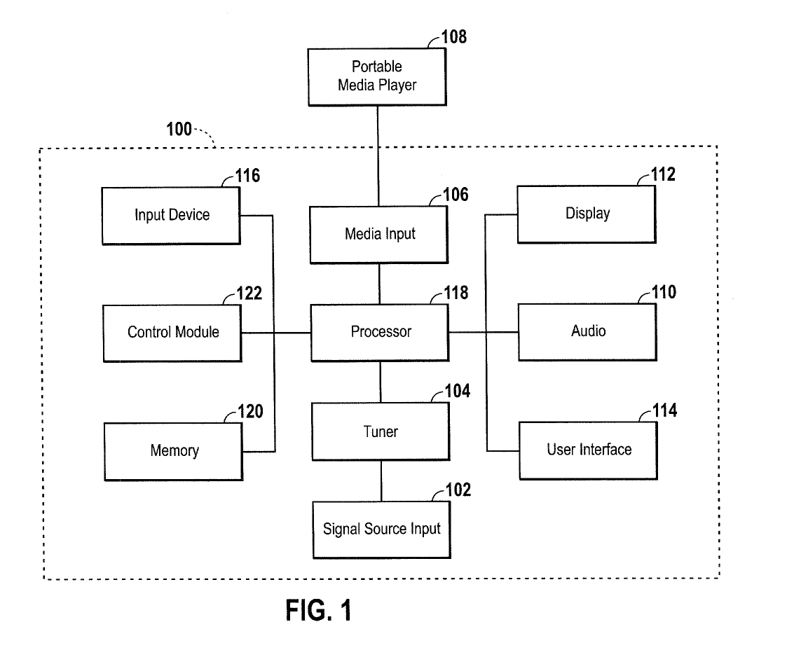

FIG. 1 is a block diagram of an electronic device in accordance with an embodiment of the present invention. The electronic device is generally indicated by reference number 100. The electronic device 100 (a television, for example) comprises various subsystems represented as functional blocks in FIG. 1. Those of ordinary skill in the art will appreciate that the some of the functional blocks shown in FIG. 1 may comprise hardware elements (including circuitry), software elements (including computer code stored on a machine-readable medium), or a combination of both hardware and software elements.

The electronic device 100 includes a signal source input 102 for receiving media to present via the electronic device 100. The signal source input 102 may include an antenna input, an RCA input, an S-Video input, a composite video input, or the like. Those of ordinary skill in the art will appreciate that the signal source input 102 may be representative of multiple inputs. The signal source input 102 is configured to receive a signal that comprises video data and, in some cases, audio data. The signal received by the signal source input 102 may include a broadcast spectrum (e.g., if the signal source input 102 comprises an antenna input), a television broadcast received from a cable or satellite receiver, or a single channel of video and/or audio data (e.g., if the signal source input 102 comprises a DVD player input, or the like).

In the illustrated embodiment, a tuner 104 is configured to tune a particular video program from a broadcast signal received from the signal source input 102. For example, the tuner 104 may be used to select and tune a channel from a variety of channels provided through cable television to display a program being broadcast on the tuned channel. In some embodiments, the tuner 104 may be bypassed if the signal source input 102 receives a signal that does not require tuning, such as a stored video signal. Indeed, those of ordinary skill in the art will appreciate that input signals that are not received as part of a broadcast spectrum may bypass the tuner 104 because tuning is not required to isolate a video program associated with those signals.

The electronic device 100 also includes a media input 106 for receiving media to present via the electronic device 100. The media input 106 includes a dedicated connection of a type different from the signal source input 102. As noted above, the signal source input 102 may include a traditional analog or digital connection, such as an S-Video input, coaxial input, or HDMI input, for receiving audio and digital signals from an external unit such as a VCR or DVD player. In contrast, the media input 106 may include a dedicated connection that facilitates control of an external unit using a bus interface, serial interface, or the like. According to certain embodiments, the media input 106 may include a wireless connection, a serial connection, a Universal Serial Bus (USB) connection, an Inter-Integrated Circuit (I²C) connection, or other suitable connection for communicating with an external unit, such as a portable media player 108.

The portable media player 108 includes a self-contained and portable electronic device configured to store and play digital media. Moreover, the portable media player 108 includes a device that is easily transported by a user and capable of independent use in a variety of environments, such as while traveling in a plane or while working out. For example, the portable media player 108 may include an audio, video, or multi-media player such as an iPod® commercially available from Apple, Inc., a Zune commercially available from Microsoft, a LYRA™ commercially available from RCA, or the like.

The portable media player 108 may be connected to the media input 106 by a cable, such as a serial cable or I²C cable, or may communicate with the media input 106 using wireless signals. Those of ordinary skill in the art will appreciate that the media input 106 may be representative of multiple inputs, allowing connection to many portable media players and/or other external devices.

In addition to receiving media, such as video files or streaming signals, from the portable media player 108, the media input 106 may be configured to transmit media files to the portable media player 108 from the device 100. For example, video recorded on the device 100 may be transmitted to the portable media player 108 to allow the recorded video to be stored on the portable media player 108 and accessed on the portable media player 108 even after disconnection from the device 100. The media input 106 also may be configured to allow communication of command and control information between the electronic device 100 and the portable media player 108, thereby allowing control of the portable media player 108 through the electronic device 100. For example, directory information, such as menus and playlists, may be transmitted to the electronic device 100 from the media player 108 via the media input 106.

An audio subsystem 110 and a display subsystem 112 of the device 100 are configured to play the audio and video information received from the signal source input 102 and the media input 106. The audio subsystem 110 may include an audio amplifier and one or more speakers configured to play audio data. For example, the audio subsystem 110 may play music received from the portable media player 108. The display subsystem 112 may include a lighting source and a display, such as a liquid crystal display, a light emitting diode display, a plasma display panel, or a digital light projection display configured to play video data. In operation, the display subsystem 112 may display album art or videos received from the portable media player 108. In another example, the display subsystem 112 may display a menu for navigating within the portable media player 108.

A user interface 114 may include a graphical user interface having a plurality of menus, viewable through the display subsystem 112. The user interface 114 may be configured to allow a user to adjust various settings and/or options for the electronic device 100. One setting may include selecting or changing the input to the electronic device 100. For example, a menu of the user interface 114 may be configured to facilitate selection of the signal source input 102 and the media input 106. It is important to note that the selectable options for the signal source input 102 and the media input 106 may be included within the same menu. This facilitates direct selection of the media input 106. Consequently, a user may avoid time consuming and annoying navigation of complex menu systems.

Accordingly, the user interface 114 may be configured to allow a user to select a particular input, such as each of the inputs 102 and 106, as the media source for the electronic device 100. When an input is selected on the user interface 114, the device may be configured to receive data through the selected input. For example, a user may select an S-Video input, provided as a signal source input 102, to view video from a DVD player. When the user is finished using the DVD player, the user may select a portable media player input, provided as a media input 106, to view video stored on the portable media player 108. When the user is finished with the portable media player 108, the user may select a cable input, provided as a signal source input 102, to view a cable television program. In this manner, a user may access data from various sources and devices connected to the electronic device 100, by selecting the inputs corresponding to each source and device.

An input device 116 may be used to navigate through the user interface 114. The input device 116 may include control features, such as selection buttons, dials, knobs, or the like disposed on an outer surface of the device. According to certain embodiments, the input device 116 may include a remote control configured to communicate with the electronic device 100 via infrared signals. For example, a user may press a button on the input device 116 to cycle through the signal source inputs 102 and the media inputs 106. It is important to note that the same button may be used to access the signal source input 102 and the media input 106. This incorporates selection of the media input 106 into functionality provided for the electronic device. Consequently, manufacturers may avoid unnecessary costs associated with providing a dedicated button for selecting such a dedicated media input.

Accordingly, the input device 116 may be configured to select an input each time a button is actuated. For example, according to certain embodiments, pressing the button a first time may select a first signal source input 102, such as a cable input; pressing the button a second time may select a second signal source input 102, such as an S-Video input; and pressing the button a third time may select the media input 106. In certain embodiments, the user interface 114 may be configured to display the currently selected input. Moreover, in certain embodiments, the electronic device 100 may be configured to only select inputs connected to an external device. For example, if nothing is connected to the S-Video input, the user interface 114 may not display the S-Video input on the menu and/or the input device 116 may skip over the S-Video input and select the next input in the cycle. As discussed below, when the media input 106 is selected, the electronic device 100 is configured to access the portable media player 108. In some embodiments, selection of the media input 106 may facilitate control of the portable media player 108 via the electronic device 100.

When the media input 106 is selected, the user interface 114 may allow a user to navigate within and control the portable media player 108. For example, the user interface 114 may be configured to display menus corresponding to the menus of the portable media player 108. By manipulating the input device 116 to navigate through the menus, a user may operate the portable media player 108 and perform functions, such as displaying images stored on the portable media player 108, transferring media to the portable media player 108, and selecting content from the portable media player 108 to play on the electronic device 100.

A processor 118 of the device 100 may be configured to control operation of the electronic device 100 and cooperate with a memory 120 and a portable media player control module 122. The memory 120 may store executable code, data, and instructions for the processor 118. For example, the memory 120 may be configured to hold machine-readable code for operating the portable media player 108 in accordance with present embodiments. The processor 118 may utilize the code stored in the memory 120 to perform certain methods in accordance with present embodiments, including selection of the media input 106 as the media source for the device 100. The memory 120 also may receive and store menu configurations corresponding to menus of the portable media player 108.

A control module 122 is configured to allow the electronic device 100 to communicate with the portable media player 108. For example, the control module 122 may store protocol information and instructions corresponding to the protocol needed to communicate with the portable media player. The control module 122 also may store an authentication key required to complete a handshaking process with the portable media player 108. In another embodiment, the control module 122 may include a chip containing an authentication key and/or protocol information. In certain embodiments, the chip may be provided by the manufacturer of the portable media player 108.

Those of ordinary skill in the art will appreciate that each portable media player may require different protocols and authentication keys. Therefore, the control module 122 may store protocol information and instructions corresponding to the protocols and keys used by many different types, models, and/or brands of media players. Although shown in FIG. 1 as a separate component, it should be appreciated that the control module 122 may be integrated into the processor 118 and/or memory 120. Further, in certain embodiments, the control module 122 may be contained within an external device connected to the electronic device 100 through a signal source input 102 or a media input 106.

In the illustrated embodiment, the electronic device 100 is configured to facilitate access or control of the portable media player 108 through the electronic device 100. To access the portable media player 108, a user may actuate a control feature, such as a button, on the input device 116 to switch the media source for the electronic device 100 to the media input 106. A single button used for normal input switching may be configured to allow access to the portable media player 108. For example, the same button utilized to cycle between signal source inputs 102 may also be utilized to select the media input 106. Indeed, a proprietary connector that enables integrated control of the portable media player 108 may cooperate with control features of the device 100 to facilitate user selection of a dedicated connection to the portable media player 108 by cycling through available inputs (e.g., signal source inputs 102 and the media input 106). Consequently, a user may access the portable media player 108 without navigating through a series of menus and without using a special control feature dedicated to the portable media player 108.

When the media input 106 is selected, the electronic device may be configured to enter an operational mode, such as a context sensitive mode, for controlling the portable media player 108. In this mode, the input device 116 may be used to navigate through menus of the portable media player 108 displayed on the display subsystem 112. The menus may be part of the user interface 114. Additionally, in certain embodiments, the user may manipulate the input device 116 to directly control the portable media player 108. For example, the user may press a button on the input device 116 corresponding to the “play” command to play the music stored on the portable media player 108. In another example, the user may press a button corresponding to the “record” command to record media to the portable media player 108.

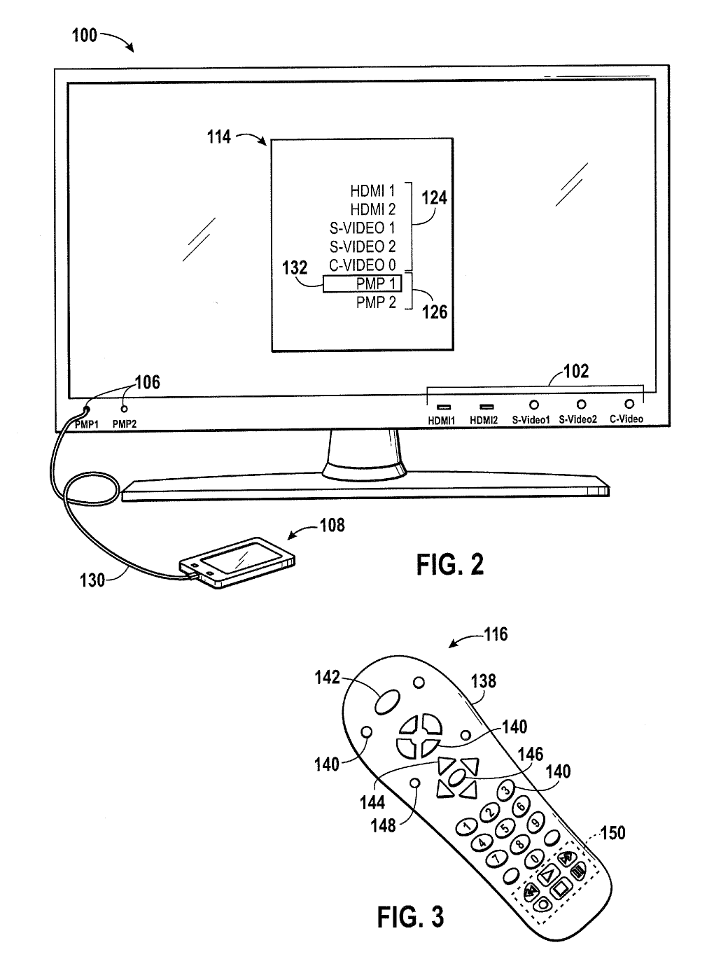

FIG. 2 depicts one embodiment of an electronic device 100 connected to a portable media player 108. In the illustrated embodiment, the electronic device 100 includes a television displaying a user interface 114. The user interface 114 includes a textual listing of the signal source inputs 102 and the media inputs 106 available for the electronic device 100. The signal source inputs 102 and the media inputs 106 may be labeled with text corresponding to indicators 124 and 126 displayed on the user interface 114 to facilitate selection of an indicator 124 or 126 and corresponding input 102 or 106. In certain embodiments, the inputs 102 and 106 may not be labeled. As those skilled in the art will appreciate, in certain embodiments, the inputs 102 and 106 may be disposed on the rear or side of the electronic device 100.

According to certain embodiments, the signal source input 102 may be connected to external devices such as a DVD player or may be configured to receive a cable broadcast. As shown, the electronic device 100 includes five signal source inputs 102 that may be configured to receive data from external devices. Each of these signal source inputs 102 is represented in the user interface 114 by a corresponding indicator 124 (e.g., HDMI1, HDMI2, S-Video1, S-Video2, and C-Video). When a signal source input 102 is selected as the media source, the electronic device 100 may receive data from the external device connected to the selected input. For example, the signal source input 102 that is labeled as S-Video1 may be coupled to a DVD player and configured to play movies when the S-Video1 indicator 124 is selected.

The electronic device 100 also includes two media inputs 106, represented on the user interface 114 by corresponding indicators 126 (e.g., PMP1 and PMP2). Each of the media inputs 106 is configured to receive data from a portable media player. In other embodiments, the electronic device may include only one media input or may include numerous media inputs. Moreover, as those skilled in the art will appreciate, many configurations of user interfaces may be employed. For example, instead of the textual indicators 124 and 126, the user interface 114 may include graphical icons representing the inputs 102 and 106.

The electronic device 100 may be configured to receive data, such as video and audio files, through the media inputs 106. However, although the electronic device 100 may be configured to receive data through multiple signal source inputs 102 and media inputs 106, the electronic device 100 may display only the data received through the selected input. For example, a user may select the HDMI1 indicator 124 to view a cable broadcast and may select the S-Video1 indicator 124 to view a movie using a DVD player. In another example, the user may select the PMP1 indicator 126 to view media from the portable media player 108, and the user may select the PMP2 indicator 126 to view from a second portable media player (not shown). In this manner, multiple devices and portable media players may be connected to the television and accessed by selecting the corresponding input for the device (e.g., the input to which the device is connected). Each of the external devices (e.g., DVD players, portable media players, cable receivers) may be accessed using the same process (e.g., cycling through the available inputs until the desired input is selected).

In the illustrated embodiment, the portable media player 108 is connected to the input 106 labeled as PMP1 using a communication link 130, shown here as a cable. The communication link 130 may include a serial cable, a USB cable, a wireless connection, or the like. Although only one portable media player is shown in FIG. 2, those skilled in the art will appreciate that a second portable media player may be connected to the electronic device 100 through the input 106 labeled as PMP2. When a second portable media player is connected, the electronic device is configured to display media from the second portable media player when the PMP2 indicator 126 is selected. The user interface 114 may include an indication 132, shown here as a selection box, that visually indicates which indicator, and consequently which corresponding input, is selected. In FIG. 2, the indication 132 is disposed around the PMP1 indicator 126 to show that the PMP1 indicator 126 is currently selected. In other embodiments, the indication 132 may include other types of visual indicators such as an arrow, highlighting, or a color graphic.

FIG. 3 depicts one embodiment of an input device 116 that may be configured to select the input for the electronic device 100. The input device 116, shown here as a remote control, is enclosed by a body 138 that protects the interior components from damage. The input device 116 includes control features, indicated generally by reference numeral 140, configured to allow a user to control the electronic device 100 (FIG. 2). For example, the control features 140 may be actuated by a user to change settings on the electronic device such as the volume, the brightness, and the tuner channel.

A control feature 142 is configured to designate the input for the electronic device. For example when actuated, the control feature 142 may send a signal to the electronic device 100 (FIG. 2) to select an input as the media source. In accordance with certain embodiments, the control feature 142 may be configured to progressively select each available input when actuated. For example, when actuated a first time, the control feature 142 may select the input HDMI1 (FIG. 2), and when actuated a second time, the control feature 142 may select the input HDMI2 (FIG. 2). In this manner, a user may actuate the control feature 142 to progressively switch the input to each input available for the electronic device 100. The available inputs may include all inputs included within the electronic device 100 regardless of whether the inputs are connected to external devices. However, according to certain embodiments, the electronic device 100 may be configured to sense when an input is connected to an external device and only include connected inputs as the available inputs cycled through using the control feature 142.

In other embodiments, multiple control features 140, such as arrows 144 and a selection button 146, may be configured to allow a user to navigate through menus shown on the user interface 114. For example, the arrows 144 may be used to place the indication 132 (FIG. 2) over the desired indicator, and the selection button 146 may be used to select the indicator and set the media source to the corresponding input. The control features 140 also may include a guide button 148 that is configured to display a media guide for the electronic device 100 when actuated. For example, when the electronic device 100 is configured to receive data through an input connected to a cable broadcast, actuating the guide button 148 may display a cable television programming guide on the electronic device 100. In another example, when the electronic device 100 is configured to receive data through an input connected to the portable media player 108 (e.g., input PMP1 shown in FIG. 2), actuating the guide button 148 may display a media guide describing content stored on the portable media player 108. Actuation of the guide button 148 may send a control signal to the electronic device 100 to request information from the appropriate external device. In response to the control signal, the electronic device 100 may acquire information and display the information in the form of a guide. The arrows 144 and the select button 146 may be used to navigate within the guide and select content to play on the electronic device 100.

The input device 116 also may include control features 150 configured to control external devices connected to the available inputs. According to certain embodiments, the electronic device may be configured to enter a context sensitive mode when each input is selected as the media source, allowing the same control features 150 to control multiple external devices. For example, when a signal source input 102 (FIG. 2) is selected, the control features 150 may be used to control a DVD player connected to the input S-Video1. Each control feature 150 may correspond to DVD functions such as play, fast forward, stop, or record. When a media input 106 (FIG. 2) is selected, the control features 150 that were previously used to control the DVD player may be used to control the portable media player 108. Moreover, in other embodiments the control features 150 may be device specific and only configured to control one type of external device. In these embodiments, multiple sets of control features 150 may be provided to allow control of multiple devices.

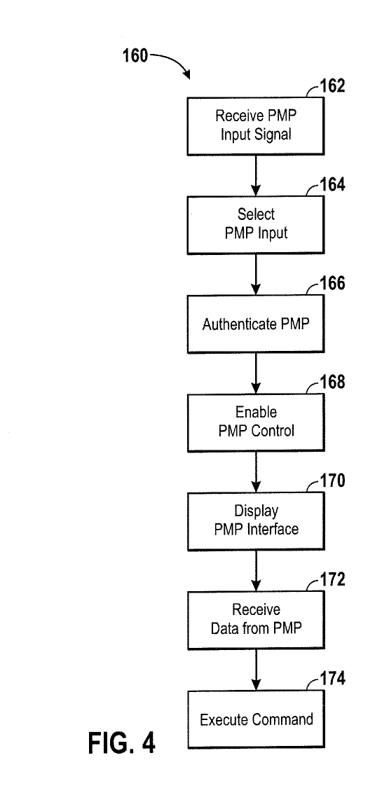

FIG. 4 is a process flow diagram of a method 160 in accordance with present embodiments. In some embodiments, as those of ordinary skill in the art will appreciate, some steps may be modified, excluded, or additional steps may be included. The method begins by receiving an input signal designating an input in communication with a portable media player (step 162). According to certain embodiments, the signal may include a control signal received from an input device 116 (FIG. 1), such as a remote control. In response to the control signal, the electronic device selects the designated portable media player input (step 164) as the media source. The selection may be performed by cycling through the available inputs until the designated portable media player input is selected. According to certain embodiments, the portable media player input may include a media input 106 (FIG. 1) and may be selected from multiple available signal source inputs 102 (FIG. 1) and media inputs 106 (FIG. 1).

To enable communication between the electronic device 100 (FIG. 1) and the portable media player 108 (FIG. 1), an authentication process may occur (step 166). For example, a handshaking protocol may be executed within the processor 118 (FIG. 1) during which an authentication key is transmitted to the portable media player 108 (FIG. 1) to allow it to communicate with the electronic device 100 (FIG. 1). It should be noted that in certain embodiments the portable media player may not require authentication, and, therefore, the authentication process (step 166) may be omitted.

After the authentication process, the processor 118 (FIG. 1) enables portable media player control (step 168). This step may include entering a context sensitive mode where commands received from the input device 116 (FIG. 1) are configured to control the portable media player 108 (FIG. 1). In the context sensitive mode, control features 140 (FIG. 3) that normally control the electronic device 100 may be used to control the portable media player 108 (FIG. 1). For example, a guide button 148 that normally displays a cable programming guide when actuated, may be configured to display a guide for the portable media player while the device is operating in the context sensitive mode. This step also may include operating under a protocol configured to facilitate communication between the portable media player 108 (FIG. 1) and the electronic device 100 (FIG. 1).

To facilitate control of the portable media player 108 (FIG. 1), a user interface may be displayed (step 170). For example the user interface may be a graphical user interface displayed via the display subsystem 112 (FIG. 1). Moreover, the interface may include menus corresponding to the menus displayed on the portable media player 108 (FIG. 1). A user may navigate through the menus using the input device 116 (FIG. 3) to designate commands for the portable media player 108 (FIG. 1). According to certain embodiments, the control features 140 (FIG. 3) may be used to designate the commands. For example, the control features 150 (FIG. 3) that normally control playback from an external device connected to a signal source input, such as a DVD player, may be configured to control the portable media player 108 (FIG. 1) while the device is operating in the context sensitive mode. In one example, the same play button 150 (FIG. 3) used to play a DVD may be used to play video or audio files stored on the portable media player 108 (FIG. 1).

The electronic device 100 (FIG. 1) is configured to receive data from the portable media player 108 (FIG. 1), generally in response to control signals generated by the input device 116 (FIG. 1). For example, a user may enter a command, such as a play video command, using the input device 116 (FIG. 1). The input device 116 (FIG. 1) may send a control signal corresponding to the command to the electronic device 100 (FIG. 1). In response to the signal, the electronic device 100 (FIG. 1) may request and receive data (step 172) from the portable media player 108 (FIG. 1). As noted above, the electronic device 100 (FIG. 1) may communicate with the portable media player 108 (FIG. 1) using a protocol, such as an I²C protocol. The data may be transmitted over a communication link, such as a serial cable, wireless connection, or USB cable. The electronic device may then process the data, where appropriate, and execute the command (step 174). For example, the command may include playing an audio or video file stored on the portable media player 108 (FIG. 1). In another example, the command may include displaying menu, directory, or file information stored on the portable media player 108 (FIG. 1). Once the command is executed, the electronic device may wait for a subsequent control signal relating to another command. In this manner, the electronic device 100 (FIG. 1) is configured to control operation of the portable media player 108 (FIG. 1).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An electronic device, comprising:
a plurality of inputs including a first input that is a dedicated input for a portable media player;
an input device configured to send a control signal that cyclically selects each of the plurality of inputs; and
a control module configured to enable a processor to communicate with the portable media player while the first input is selected.

2. The device of claim 1, comprising a display subsystem configured to display media stored on the portable media player.

3. The device of claim 2, wherein the input device includes a button configured to acquire first information through the first input and second information through a second input of the plurality of inputs, and display the first information or the second information on the display subsystem.

4. The device of claim 3, wherein the first information includes a menu related to the portable media player and the second information includes broadcast programming guide.

5. The device of claim 1, wherein the processor is configured to transmit data to the portable media player through the first input.

6. The device of claim 1, wherein the input device includes a control feature configured to generate the control signal a first time to select the first input and a second time to select a second input of the plurality of inputs.

7. The device of claim 6, comprising a tuner configured to tune a desired program received through a second input of the plurality of inputs.

8. The device of claim 7, wherein a control feature of the input device is configured to control the electronic device while the second input is selected, and the portable media player while the first input is selected.

9. The device of claim 1, wherein the electronic device is configured to receive data through a selected input, and is configured to enter a context sensitive mode upon selection of the first input, wherein the context sensitive mode facilitates control of the portable media player through the electronic device.

10. A method of using an electronic device to access a portable media player, comprising:
receiving a control signal that cyclically designates a first input from a plurality of inputs;
selecting the first input in response to the control signal; and
receiving data from the portable media player through the first input.

11. The method of claim 10, comprising authenticating the portable media player to allow communication between the portable media player and the electronic device.

12. The method of claim 10, comprising displaying a user interface to facilitate control of the portable media player.

13. The method of claim 10, comprising executing a command relating to the data, wherein executing the command includes playing a video file stored on the portable media player.

14. The method of claim 10, comprising enabling an input device to control the portable media player, wherein the input device is configured to control the electronic device.

15. The method of claim 14, wherein the enabling includes entering a context sensitive mode where a control feature of the input device is configured to control the portable media player upon selection of the first input and to control the electronic device upon selection of a second input of the plurality of inputs.

16. The method of claim 15, comprising displaying a menu relating to the portable media player in response to actuation of a guide button while the first input is selected, wherein the guide button is configured to display a broadcast programming guide while the second input is selected.

17. An electronic device, comprising:
a plurality of inputs including a dedicated first input configured to receive a communication link for a portable media player and a second input configured to receive a television broadcast;
an input device including a control feature configured to cyclically select each of the plurality of inputs, and a guide button configured to acquire information from the portable media player while the first input is selected and to acquire information relating to the television broadcast while the second input is selected; and
a processor configured to communicate with the portable media player through the first input and configured to execute a portable media player command in response to a signal received from the input device.

18. The device of claim 17, wherein the plurality of inputs includes a signal source input, and the first input is one of a serial input, a Universal Serial Bus input, and an Inter-Integrated Circuit input.

19. The device of claim 17, comprising a display subsystem configured to play a television program while the second input is selected and to play media stored on the portable media player while the first input is selected.

20. The device of claim 17, comprising protocol information and authentication information stored within a memory of the device.
